(19) United States
(12) Patent Application Publication
(10) Pub. No.: US 2026/0316301 A1
(43) Pub. Date: Oct. 15, 2026

(54) SOFT PNEUMATIC ACTUATOR, GRIPPER ASSEMBLY, AND METHOD FOR MANUFACTURING SOFT PNEUMATIC ACTUATOR

(71) Applicants: I-HUB FOR ROBOTICS AND AUTONOMOUS SYSTEMS INNOVATION FOUNDATION, Bangalore (IN); MINISTRY OF HEAVY INDUSTRIES (MHI), GOVERNMENT OF INDIA, New Delhi (IN)

(72) Inventors: Kaushik Sampath, Bangalore (IN); Atirav Seth, Bangalore (IN); Susmith Chempodil Suseelan, Bangalore (IN)

(73) Assignees: I-HUB FOR ROBOTICS AND AUTONOMOUS SYSTEMS INNOVATION FOUNDATION, Bangalore (IN); MINISTRY OF HEAVY INDUSTRIES (MHI), GOVERNMENT OF INDIA, New Delhi (IN)

(21) Appl. No.: 19/357,073

(22) Filed: Oct. 13, 2025

(30) Foreign Application Priority Data
Oct. 18, 2024 (IN) 202441079413

(51) Int. Cl. B25J 15/12; B25J 15/00

(52) U.S. Cl. CPC B25J 15/12; B25J 15/0023; B25J 15/0033

(57) ABSTRACT

The present disclosure provides soft pneumatic actuator (SPA) comprising: soft finger (SF) moulded as unibody part, pneumatic connector configured to pneumatically couple SF with pneumatic source; barbed fitting capable of being partially arranged into second end of SF and partially arranged into pneumatic connector, and module hub. The SF comprising: hollow bellowed structure capable of being deformed under pneumatic pressure, hollow bellowed structure being located between first end and second end of SF, thickness of second end being greater than thickness of first end; and a strain-limiting layer integrated with hollow bellowed structure at the first end of SF, wherein the strain-limiting layer is configured to enable a deformation of the hollow bellowed structure in a controlled manner. The module hub adapted to: securely hold SF, pneumatic connector, and barbed fitting together, during an operation of SPA; and integrate the SPA into pneumatic gripper assembly.

### CROSS-REFERENCE TO RELATED APPLICATIONS

This application does not claim priority to any prior U.S. or foreign application. However, reference is made to Indian Provisional Patent Application No. 202441079413, filed on Oct. 18, 2024, titled “SOFT PNEUMATIC ACTUATOR AND GRIPPER ASSEMBLY, AND METHOD AND SYSTEM FOR MANUFACTURING THEREOF”, the subject matter of which is incorporated herein by reference in its entirety.

### TECHNICAL FIELD

The present disclosure relates to soft pneumatic actuators. The present disclosure also relates to gripper assemblies. Furthermore, the present disclosure relates to methods for manufacturing soft pneumatic actuators.

### BACKGROUND

The automation and robotic industries increasingly rely on advanced manipulation technologies to handle a diverse range of materials, particularly soft and fragile objects. Typically, soft pneumatic actuators (SPAs) have been developed to enable delicate and precise control in such applications. However, an effective integration of the SPAs into end-of-arm tooling (EOAT) systems presents a series of technical challenges. These challenges include need for cost-effective manufacturing processes, ability to customize actuators for specific tasks, and reliability of the actuators under varying operational conditions. Conventional SPAs and gripper assemblies, while capable of handling delicate objects, face limitations in terms of durability and adaptability. Under high-pressure operations, the SPAs are prone to stress concentrations in specific regions, potentially leading to premature material failure or performance degradation. Additionally, the placement of parting lines during manufacturing can result in non-uniform material distribution, particularly in critical pressurized areas, which further compromises structural integrity and longevity of a soft pneumatic actuator (SPA). As the automation continues to evolve, there is a critical need for improved design of the SPA that can meet these demands efficiently and effectively.

Conventionally, existing solutions in the field of the SPA primarily rely on traditional manufacturing techniques, for example, such as Liquid Silicone Rubber (LSR) injection moulding. This method, while capable of producing durable and functional actuators, involves complex tooling requirements and extended production cycles. For example, some existing manufacturers have developed various SPAs that offer enhanced gripping capabilities, however these products are often limited by their high production costs and low adaptability to changing application needs. As a result, the reliance on large batch sizes and specific tooling further restricts flexibility and accessibility of the SPAs for small to medium enterprises, which are increasingly looking for cost-effective and customizable automation solutions. The intricacies involved in the LSR injection moulding can lead to challenges in achieving consistent quality across large production runs, which can further inflate reliability costs due to potential defects and failures in the field. Moreover, existing solutions often face limitations related to their operational reliability and performance under extreme conditions (for example, such as high temperatures). Additionally, the lack of innovative sealing techniques and modular design features can lead to inefficiencies, increasing downtime and maintenance costs.

Therefore, in the light of foregoing discussion, there exists a need to overcome the aforementioned drawbacks.

### SUMMARY

A primary objective of the present disclosure seeks to provide a soft pneumatic actuator (SPA) that enhances performance by enabling precise manipulation of soft and fragile objects, improving durability through optimized structural integrity, and increasing adaptability to various operational conditions. Another objective of the present disclosure seeks to provide a gripper assembly that ensures reliable and adjustable gripping force, enhances compatibility with different robotic systems, and facilitates efficient object handling with minimal energy consumption. Another objective of the present disclosure seeks to provide a method for manufacturing at least one soft pneumatic actuator (SPA) that provides an improved manufacturing efficiency (specially reducing production time and resource utilization), enhanced design flexibility, and reduced production costs through use of a simplified compression moulding process with interchangeable moulds. An aim of the present disclosure is to provide a solution that overcomes at least partially the problems encountered in prior art.

In a first aspect, an embodiment of the present disclosure provides a soft pneumatic actuator comprising:
a soft finger moulded as a unibody part, the soft finger comprising:
   a hollow bellowed structure capable of being deformed under a pneumatic pressure, the hollow bellowed structure being located between a first end and a second end of the soft finger, a thickness of the second end being greater than a thickness of the first end; and
   a strain-limiting layer integrated with the hollow bellowed structure at the first end of the soft finger, wherein the strain-limiting layer is configured to enable a deformation of the hollow bellowed structure in a controlled manner;
a pneumatic connector configure to pneumatically couple the soft finger with a pneumatic source;
a barbed fitting capable of being partially arranged into the second end of the soft finger and partially arranged into the pneumatic connector, to provide a pneumatic sealing between the soft finger and the pneumatic connector; and
a module hub adapted to:
   securely hold the soft finger, the pneumatic connector, and the barbed fitting together, during an operation of the soft pneumatic actuator; and
   integrate the soft pneumatic actuator into a pneumatic gripper assembly.

The main advantage of the first aspect of the present disclosure is that it offers a structurally optimized soft pneumatic actuator (SPA) that enhances durability, reliability, and precision in manipulation tasks. By utilizing a unibody-moulded soft finger, the SPA minimizes assembly complexities and potential failure points, ensuring consistent performance over extended operational cycles. The hollow bellowed structure, with its varying thickness profile, allows controlled deformation under pneumatic pressure, thereby improving force distribution and enabling precise handling of delicate or irregularly shaped objects. Additionally, the integration of the strain-limiting layer ensures predictable and repeatable deformation, preventing excessive strain and material fatigue. It will be appreciated that the use of the barbed fitting and the pneumatic connector facilitates a secure and airtight coupling, thereby preventing leakage and optimizing pneumatic efficiency. Furthermore, the inclusion of the module hub provides a robust mechanical interface that securely holds all components together, while also enabling seamless integration into the pneumatic gripper assembly, thereby enhancing the adaptability of the SPA across various robotic and automation applications.

In a second aspect, an embodiment of the present disclosure provides a gripper assembly comprising:
at least one soft pneumatic actuator as claimed in a first aspect;
a frame configured to support the at least one soft pneumatic actuator;
an arm connector configured to connect the frame to a robotic arm that is to be deployed for performing at least one object manipulation task;
a controller box comprising at least one electrically-actuated element to control an actuation of the at least one soft pneumatic actuator; and
at least one pneumatic coupling element configured to pneumatically couple a pneumatic connector of the at least one soft pneumatic actuator with a pneumatic source.

The main advantage of the second aspect of the present disclosure is that it provides a highly adaptable and efficient gripper assembly capable of precise and reliable object manipulation in robotic and automation applications. By incorporating the at least one SPA, the gripper assembly benefits from a compliant and dexterous gripping mechanism that can securely handle delicate, irregularly shaped, or fragile objects with minimal risk of damage. It will be appreciated that an inclusion of the frame ensures structural stability and supports multiple actuators, allowing for customizable configurations to accommodate various operational requirements. The arm connector facilitates seamless integration with robotic arms, enabling automated handling across diverse industrial and research applications. Additionally, the controller box with electrically actuated elements allows precise modulation of pneumatic actuation, enhancing control over gripping force and motion. Moreover, the at least one pneumatic coupling element ensures efficient pneumatic connectivity, optimizing response time and reliability of the SPA. Overall, this aspect improves versatility, efficiency, and performance of robotic grippers in industries such as manufacturing, logistics, healthcare, and similar.

In a third aspect, an embodiment of the present disclosure provides a method for manufacturing at least one soft pneumatic actuator as claimed in a first aspect, the method comprising:
employing at least one of: milling, casting, stereolithography, machining, extrusion, to manufacture at least two cavity moulds and a core mould for a soft finger, wherein the at least two cavity moulds define an external geometry of the soft finger, and the core mould defines an internal geometry of the soft finger;
employing compression moulding to mould the soft finger as a unibody part using the at least two cavity moulds, the core mould, and a flexible material for the soft finger;
employing at least one of: injection moulding, milling, casting, stereolithography, machining, extrusion, to manufacture a pneumatic connector, a barbed fitting, and a module hub; and
assembling the soft finger, the pneumatic connector, the barbed fitting, and the module hub.

The main advantage of the third aspect of the present disclosure is that it provides a precise, efficient, and scalable manufacturing method for producing the at least one SPA with high structural integrity and performance consistency. By employing advanced fabrication techniques such as milling, casting, stereolithography, machining, and extrusion, the method enables creation of highly accurate moulds that define both external and internal geometries of the soft finger. It will be appreciated that the use of the compression moulding ensures that the soft finger is formed as a unibody part, eliminating weak points associated with multi-part assembly and enhancing its durability under repeated actuation cycles. The resultant SPA produced through the compression moulding process utilizes interchangeable two-cavity moulds designed to facilitate creation of various SPA variants. Additionally, the flexibility of this manufacturing approach allows for the production of the soft finger from various materials, such as high-consistency rubber, thermoplastic elastomers, and similar, optimizing their mechanical properties for specific applications. Moreover, the method enhances manufacturability, reliability, and adaptability of the at least one SPA for industrial and robotic applications.

Embodiments of the present disclosure substantially eliminate or at least partially address the aforementioned problems in the prior art, and enable an efficient, reliable, and cost-effective manufacturing of a soft pneumatic actuator (SPA) through a simplified compression moulding process. This approach not only streamlines the production process but also allows for greater design flexibility, resulting in a resultant SPA that can be customized for various applications.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of embodiments, is better understood when read in conjunction with the appended drawings. For the purpose of illustrating the present disclosure, exemplary constructions of the disclosure are shown in the drawings. However, the present disclosure is not limited to specific instrumentalities disclosed herein. Moreover, those in the art will understand that the drawings are not to scale.

Embodiments of the present disclosure will now be described, by way of example only, with reference to the following diagrams wherein:

FIG. 1 illustrates a structural representation of a soft pneumatic actuator (SPA), in accordance with an embodiment of the present disclosure;

FIG. 2 illustrates a representation of a webbed feature incorporated in the SPA, in accordance with an embodiment of the present disclosure;

FIGS. 3A-E illustrate different exemplary cross-sectional views of the webbing feature incorporated in the SPA, in accordance with an embodiment of the present disclosure;

FIG. 4 illustrates a structural representation of a gripper assembly, in accordance with an embodiment of the present disclosure;

FIG. 5 illustrates steps of a method for manufacturing at least one SPA, in accordance with an embodiment of the present disclosure;

FIG. 6 illustrates a representation of a three-part mould for production of the soft finger, in accordance with an embodiment of the present disclosure;

FIG. 7A illustrates a construction technique for modelling of the soft finger of an exploded views of the SPA, while FIGS. 7B and 7C illustrate exploded views of the SPA, in accordance with an embodiment of the present disclosure;

FIGS. 8A-D illustrate different exemplary views of revolve bellow-based modelling of a soft finger with super eclipse cross sections and cosinusoidal guide curves, in accordance with an embodiment of the present disclosure;

FIGS. 9A-D illustrate different exemplary views of revolve bellow-based modelling of a soft finger with conic semicircular sections and cosinusoidal guide curves, in accordance with another embodiment of the present disclosure;

FIGS. 10A-D illustrate different exemplary views of revolve bellow-based modelling of a soft finger with triangular sections and cosinusoidal guide curves, in accordance with yet another embodiment of the present disclosure;

FIGS. 11A-C illustrate different exemplary views of rule surface modelling of a soft finger with triangular sections and cosinusoidal guide curves, in accordance with still another embodiment of the present disclosure;

FIGS. 12A-C illustrate different exemplary views of rule surface modelling of a soft finger with super ellipse cross sections and cosinusoidal guide curves, in accordance with yet another embodiment of the present disclosure;

FIGS. 13A-C illustrate different exemplary views of rule surface modelling of a soft finger with conic semicircular sections and cosinusoidal guide curves, in accordance with still another embodiment of the present disclosure; and

FIG. 14 illustrates an exemplary process flowchart representing a manufacturing process (i.e., a development process) of a soft pneumatic actuator, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

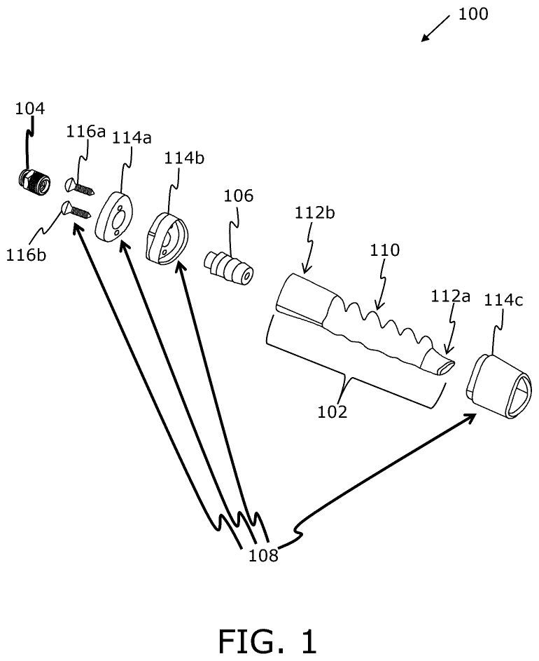

Referring to FIG. 1, illustrated is a structural representation of a soft pneumatic actuator 100, in accordance with an embodiment of the present disclosure. Herein, the soft pneumatic actuator 100 comprises a soft finger 102 moulded as a unibody part, a pneumatic connector 104 configure to pneumatically couple the soft finger 102 with a pneumatic source, a barbed fitting 106, and a module hub 108.

Herein, the soft finger 102 comprises a hollow bellowed structure 110 capable of being deformed under a pneumatic pressure, the hollow bellowed structure 110 being located between a first end 112a and a second end 112b of the soft finger 102, a thickness of the second end 112b being greater than a thickness of the first end 112a. Further, the soft finger 102 comprises a strain-limiting layer integrated with the hollow bellowed 110 structure at the first end 112a of the soft finger 102, wherein the strain-limiting layer is configured to enable a deformation of the hollow bellowed structure 110 in a controlled manner. Herein, the barbed fitting 106 is capable of being partially arranged into the second end 112b of the soft finger 102 and partially arranged into the pneumatic connector 104, to provide a pneumatic sealing between the soft finger 102 and the pneumatic connector 104. The module hub 108 is adapted to: securely hold the soft finger 102, the pneumatic connector 104, and the barbed fitting 106 together, during an operation of the SPA 100; and integrate the SPA 100 into a pneumatic gripper assembly. The module hub 108 comprises plurality of parts (depicted as 114a, 114b, 114c), and plurality of screws (depicted as screws 116a, and 116b).

FIG. 1 is merely an example, which should not unduly limit the scope of the claims herein. A person skilled in the art will recognize many variations, alternatives, and modifications of embodiments of the present disclosure.

Throughout the present disclosure, the term “soft pneumatic actuator” refers to a type of actuator designed to produce motion or force through the use of compressed air, utilizing soft, flexible materials that allow for compliance and adaptability in operation. The soft pneumatic actuator (SPA) 100, 402a-e consist of a deformable structure that changes shape when inflated, enabling to perform tasks such as grasping, lifting, and similar functions, while ensuring minimum contact force and improved manoeuvrability.

Throughout the present disclosure, the term “soft finger” refers to a flexible, deformable component of the SPA 100, 402a-e, designed to undergo controlled deformation when subjected to pneumatic pressure. Herein, the soft finger 102 is made of silicone rubber and is moulded in a metal mould where it cures and attain the final shape. Beneficially, the use of silicone provides the soft finger 102 with high elasticity and durability, ensuring that it can withstand repeated actuation without significant wear or degradation. Notably, a single-surface construction of body of the soft finger 102, mathematically defined by at least three curves, optimizes geometry of the SPA 100, 402a-e to ensure uniform stress distribution, while removable core Liquid Silicone Rubber (LSR) fabrication facilitates efficient production and assembly. Together, these design features effectively optimize top-bottom strain variation, thereby enhancing performance and reliability of the SPA 100, 402a-e during operation. The soft finger 102 is moulded as the unibody part using elastomeric materials such as high-consistency rubber (HCR), thermoplastic elastomers (TPE), and similar, ensuring structural integrity and repeatability in manufacturing.

Moreover, the soft finger 102 is the unibody part moulded using compression moulding. Herein, the soft finger 102 does not use any glue/interface between the hollow bellowed structure 110 and the strain-limiting layer integrated with the hollow bellowed structure 110 at the first end 112a of the soft finger 102. It will be appreciated that such a feature prevents delamination between different strata of the soft finger 102 since, unlike other SPA 100, 402a-e manufacturing processes, it does not depend on bonding between separately cured sections. It will also be appreciated that such a feature makes testing and certification, for example, such as food safety and stain testing, much more reliable since the unibody moulding ensures homogeneity, unlike other SPA 100, 402a-e manufacturing processes, that may use silicones cured using different curing types (platinum or tin cured) and different curing conditions, resulting in low repeatability across production batches. The use of unibody compression moulding in the soft finger 102 leads to enhanced mechanical integrity and operational reliability, especially in critical applications where compliance with stringent standards is required. For example, in food handling robots, where hygiene and safety are paramount, the homogeneity of the unibody structure ensures that the SPA 100, 402a-e can pass rigorous food safety certifications more easily. Similarly, in cleanroom environments or medical equipment, the lack of bonding interfaces reduces risk of contamination and simplifies sterilization process, making it suitable for highly controlled environments.

The term “hollow bellowed structure” refers to a deformable, air-filled component comprising a series of flexible folds or convolutions, configured to expand, contract, or bend when subjected to pneumatic pressure. Herein, the term “bellow” refers to a flexible, expandable, and contractible structure that is designed with multiple folds or corrugations. The hollow bellowed structure 110 enables controlled deformation along a predefined axis while maintaining structural integrity and repeatability in actuation. It will be appreciated that the hollow bellowed structure 110 allows controlled deformation of the soft finger 102 under the pneumatic pressure, enabling precise actuation and predictable motion for grasping and manipulation tasks. It will also be appreciated that positioning the hollow bellowed structure 110 between the first end 112a (namely, a bottom end) and the second end 112b (namely, a top end) provides a well-defined actuation region, ensuring that deformation primarily occurs in an intended section while maintaining stability at mounting points. Moreover, the term “strain-limiting layer” refers to a mechanically restrictive element integrated with a deformable structure to constrain excessive elongation, control directional deformation, and enhance force transmission. Typically, the strain-limiting layer is composed of a material with lower elasticity than surrounding flexible components, ensuring predictable motion and preventing undesired stretching or failure of the SPA 100, 402a-e. It will be appreciated that having the greater thickness at the second end 112b of the soft finger 102 compared to the first end 112a enhances mechanical durability and pneumatic sealing at an interface with the pneumatic connector 104, thereby improving reliability and preventing leakage or failure at higher operating pressures. Additionally, this feature seems to be essential for easy removal of a core mould 606 of the soft finger 102 during its manufacturing, such that its internal geometry is intact.

Optionally, the soft finger 102 is made up of a flexible material, wherein the flexible material is any one of: a high-consistency rubber, a thermoplastic elastomer. In this regard, the term “flexible material” refers to material that exhibits ability to undergo elastic or plastic deformation under an applied force and return to its original shape upon removal of a force. In context of the SPA 100, 402a-e, the flexible material allows controlled expansion, contraction, or bending of the soft finger 102 while maintaining structural integrity under repeated actuation cycles. Herein, the high-consistency rubber (HCR) is a type of silicone rubber or elastomer with a high molecular weight and a high degree of cross-linking, typically processed using compression moulding or extrusion. The HCR is characterized by its high elasticity, thermal stability, and chemical resistance, making it suitable for applications requiring durable and flexible components. The HCR is commonly used in robotics, medical devices, and food-safe applications due to its excellent mechanical and biocompatibility properties. It will be appreciated that the SPA 100, 402a-e being made up of the HCR facilitates enhanced durability and resistance to wear, enabling the SPA 100, 402a-e to withstand repeated actuation cycles without significant degradation. It will also be appreciated that the use of HCR allows the soft finger 102 to maintain its flexibility while offering superior mechanical strength, thereby ensuring a reliable operation even at higher pressures. It will further be appreciated that the high thermal stability and chemical resistance of the HCR make the SPA 100, 402a-e suitable for applications requiring exposure to varying environmental conditions, including food-safe, medical applications, and similar.

Moreover, the thermoplastic elastomer (TPE) refers to a type of polymeric materials that exhibits both thermoplastic and elastomeric properties, can be melt-processed like plastics but exhibit rubber-like elasticity at operating temperatures. The TPE offers advantages such as recyclability, flexibility, durability, and resistance to environmental factors, making them suitable for manufacturing soft robotic components, seals, and medical devices where controlled flexibility and robustness are required. The TPE could, for example, be a thermoplastic polyurethane, and similar. It will be appreciated that the SPA 100, 402a-e being made from the TPE, enables cost-effective mass production through injection moulding while maintaining required flexibility and durability for pneumatic actuation. It will also be appreciated that TPEs offer recyclability, making the SPA 100, 402a-e more sustainable compared to conventional elastomers, while still ensuring reliable pneumatic performance. It will further be appreciated that material properties of the TPE allow for precise tuning of stiffness and elasticity, enabling optimization of the SPA's 100, 402a-e force output characteristics for different applications.

A technical effect of the soft finger 102 being made up of any one of: the high-consistency rubber, the thermoplastic elastomer is that the SPA 100, 402a-e exhibits enhanced durability, flexibility, and mechanical stability, ensuring consistent performance over extended operational cycles. Additionally, the material selection enables improved manufacturability, environmental resistance, and suitability for diverse applications, including high-pressure and precision-controlled environments.

Throughout the present disclosure, the term “pneumatic connector” refers to a mechanical interface designed to establish a sealed pneumatic coupling between the SPA 100, 402a-e and the pneumatic source 410. Herein, the pneumatic connector 104 can be a push-fit type pneumatic connector. The pneumatic connector 104 facilitates controlled transfer of pressurized fluid, typically air, into the SPA 100, 402a-e to enable its deformation. The pneumatic connector 104 may include threaded fittings, barbed fittings, quick-connect couplings, or other sealing mechanisms to ensure airtight integration with the SPA 100, 402a-e while preventing leakage and maintaining operational reliability. The term “pneumatic source” refers to a device capable of supplying pressurized fluid, such as compressed air or gas, to the SPA 100, 402a-e. The pneumatic source 410 may include components such as an air compressor, a pressure regulator, a pneumatic pump, a pressurized gas reservoir, and similar. The pneumatic source 410 provides a controlled and adjustable flow of pressurized fluid necessary for actuating the SPA 100, 402a-e, ensuring repeatable and reliable deformation of the hollow bellowed structure 110.

Herein, the pneumatic connector 104 is designed to securely attach to the soft finger 102 while maintaining an airtight seal. The pneumatic connector 104 is configured to be compatible with standard pneumatic fittings and may incorporate sealing elements such as barbed fittings or threaded sections to enhance mechanical stability and prevent air leakage. The pneumatic connector 104 ensures that pressurized air is efficiently delivered into the hollow bellowed structure, enabling desired deformation pattern. It will be appreciated that a well-designed pneumatic connector 104 ensures efficient and controlled airflow, allowing for precise and repeatable actuation of the soft finger 102. It will also be appreciated that the pneumatic connector 104 helps to maintain an airtight seal, reducing energy losses due to leakage and enhancing overall efficiency of the SPA 100, 402a-e. It will further be appreciated that integration of the pneumatic connector 104 simplifies assembly and maintenance, making it easier to replace or modify components while ensuring consistent pneumatic performance. Additionally, the use of a standardized pneumatic connector 104 allows for compatibility with various pneumatic sources, thereby facilitating integration into different robotic and automation systems.

Throughout the present disclosure, the term “barbed fitting” refers to a connector component having one or more annular ridges or barbs designed to facilitate a secure mechanical and pneumatic connection between two mating elements. The barbed fitting 106 is structured to create a high-friction engagement with a deformable material, such as the soft finger 102 or the pneumatic connector 104, thereby preventing unintended detachment and ensuring a reliable pneumatic seal. The barbed fitting 106 is oversized and has an enlarged cylindrical portion to create a strong pneumatic seal and facilitate for easy removal of the core mould 606 of the soft finger 102 during its manufacturing. The term “pneumatic sealing” refers to an establishment of an airtight interface between the soft finger 102 and the pneumatic connector 104 to prevent undesired escape or ingress of gas or pressurized air. The pneumatic sealing may be achieved through mechanical compression, interference fit, elastomeric deformation, or use of specifically designed surface geometries, such as barbs, threads, gaskets, and the like, to maintain consistent pneumatic pressure within a system.

Herein, the barbed fitting 106 is intentionally designed with an oversized portion to create a compression seal when inserted into the soft finger 102 and the pneumatic connector 104. The barbs create frictional resistance, preventing unintentional detachment and maintaining a tight pneumatic seal. The fitting may have external threads or surface features that enhance gripping and sealing properties. The material selection and geometry ensures compatibility with the flexible material of the soft finger 102, preventing stress-induced damage. The larger barbed fitting 106 not only ensures effective pneumatic sealing but also simplifies removal of the core from moulded finger, contributing to improved manufacturability and production efficiency due to easier and faster core removal. The larger barbed size of the soft finger 102 enhances its ability to securely grip various objects, facilitating operation at higher pressures and enabling the use of harder HCR materials, which significantly improves life cycle while maintaining the force output characteristics of the SPA 100, 402a-e. It will be appreciated that this design reduces potential for damage to the moulded finger during core removal, thereby enhancing overall yield of the manufacturing process and ensuring consistent performance in pneumatic applications. Moreover, the barbed fitting 106 is precisely seated inside part for secure placement. This fitting is intentionally oversized to facilitate easy removal of the core during manufacturing. Additionally, the barbed fitting 106 has an internal thread that connects to pneumatic fittings, allowing easy attachment of the pneumatic push-fit connector for 6 millimetres (mm) tubing, which enables quick and leak-proof connections to air or vacuum sources. Hence, by integrating these features, the design offers enhanced reliability, ease of manufacturing, and operational flexibility, making it well-suited for applications requiring high precision and durability, for example, such as industrial automation, medical devices, soft robotics, and similar. Optionally, the SPA 100, 402a-e may be designed for underwater applications, where flexible and adaptable structure of the SPA 100, 402a-e enables to operate effectively in aquatic environments.

Optionally, a thickness of an externally-threaded portion of the barbed fitting 106 is in accordance with a thickness of an internally-threaded portion of the second end 112b of the soft finger 102. In this regard, by designing the externally-threaded portion of the barbed fitting 106 to match the internally-threaded portion of the second end 112b of the soft finger, a precise mechanical interface is achieved. The threads create a reliable interlocking mechanism that enhances stability and durability of the connection. This threading alignment ensures that the SPA 100, 402a-e functions efficiently without air loss or misalignment. It will be appreciated that matching the thickness of the threaded portions enhances structural integrity of the connection, reducing the risk of detachment or leakage under pneumatic pressure. It will also be appreciated that this configuration ensures repeatable assembly with high precision, improving manufacturing consistency and reliability in large-scale production. A technical effect of the externally-threaded portion of the barbed fitting 106 being in accordance with the internally-threaded portion of the soft finger's 102 second end 112b is that it provides a tight and secure fit between the barbed fitting 106 and the second end 112b, providing an effective pneumatic sealing and preventing leaks.

Throughout the present disclosure, the term “module hub” refers to a structural component designed to securely hold and align multiple elements of the SPA 100, 402a-e, including the soft finger 102, the pneumatic connector 104, and the barbed fitting 106. The module hub 108 facilitates integration of the SPA 100, 402a-e into a larger assembly, ensuring stability, proper pneumatic sealing, and efficient operation. Optionally, the module hub 108 comprises a plurality of parts configured to securely hold the soft finger 102, the pneumatic connector 104, and the barbed fitting 106 together, using frictional forces and multiaxial reactive forces. The plurality of parts could, for example, be made up of injection-moulded plastic materials.

Herein, the module hub 108 is mechanically designed to accommodate and retain the soft finger 102, the pneumatic connector 104, and the barbed fitting 106, either through press-fit, interlocking geometries, fasteners, adhesive bonding techniques, and similar. The module hub 108 provides a structural foundation that allows multiple actuators to be arranged in different configurations within the pneumatic gripper assembly. The module hub 108 also ensures proper alignment of pneumatic pathways, facilitating efficient air pressure distribution for actuation. A technical effect of the module hub 108 is that it enhances stability, reliability, and modularity of the SPA 100, 402a-e, allowing for seamless integration into the pneumatic gripper assembly. The module hub 108 also ensures efficient and repeatable operation by maintaining positioning and sealing of critical components, reducing performance inconsistencies and mechanical failures.

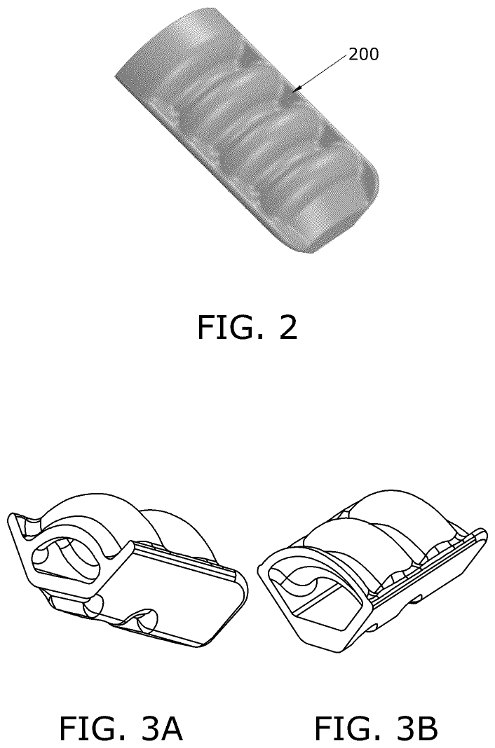

Referring to FIG. 2, illustrated is a representation of a webbed feature (depicted as 200) incorporated in the SPA 100, 402a-e, in accordance with an embodiment of the present disclosure. This innovative design introduces a webbed structure in a lateral valley regions of the SPA 100, 402a-e.

FIG. 2 is merely an example, which should not unduly limit the scope of the claims herein. A person skilled in the art will recognize many variations, alternatives, and modifications of embodiments of the present disclosure.

Optionally, the soft finger 102 further comprises a webbed feature 200 located in lateral valley regions of the soft finger 102 to reduce a stress concentration thereat, during the operation of the soft pneumatic actuator 100, 402a-e. In this regard, the term “webbed feature” refers to a structural reinforcement element that extends across or within recessed regions of a component to distribute mechanical stress more evenly. In context of the SPA 100, 402a-e, the webbed feature 200 is an integrated structure located in the lateral valley regions of the soft finger 102, designed to reduce stress concentration during deformation. The webbed feature 200 may be formed as thin connecting sections, fillets, or thickened regions, ensuring enhanced durability while maintaining flexibility. The webbed feature 200 enables an operation of the SPA 100, 402a-e at pneumatic pressures up to 1 bar.

Herein, the webbed feature 200 introduced in the lateral valley regions of the SPA 100, 402a-e, is referred to as webbed duck-feet. This feature reduces stress concentration in the valley regions by providing additional material at regions with small radii of curvature. The webbing enables the soft finger 102 to operate at higher pressures, and significantly improves life cycle while maintaining force output characteristics of the SPA 100, 402a-e. It will be appreciated that this design not only enhances durability and performance but also allows for greater versatility in application, making the SPA 100, 402a-e suitable for a wider range of operational conditions and extending its operational lifespan. As shown, duck-feet webbing effectively reduces stress concentration in the valleys by increasing material presence at the small radius of curvature regions. Herein, the term “lateral valley region” refers to specific geometrical areas within the SPA 100, 402a-e characterized by indented profiles along lateral sides of the structure of the SPA 100, 402a-e. These regions typically exhibit reduced cross-sectional thickness and sharp radii of curvature, which can lead to increased stress concentration during operation. Thus, the design of the lateral valley regions is essential in influencing mechanical performance of the SPA 100, 402a-e, including its flexibility, pressure distribution, and overall structural integrity. Moreover, the term “valley” refers to a concave surface or an indentation formed between elevated structures or features. The valley is characterized by its lowest point in the actuator's profile and plays a crucial role in influencing mechanical properties of the SPA 100, 402a-e, including stress distribution and flexibility. The valleys are integral to the overall design, affecting how the SPA 100, 402a-e deforms under pressure and interacts with its environment, ultimately contributing to its performance and functionality. Notably, the term “webbing” refers to an addition of thin, flat sections of material between adjacent structural components in a design, typically introduced to reinforce areas subject to high stress or strain. This feature distributes mechanical loads more evenly by providing additional material at critical points, thereby reducing localized stress concentrations that can lead to premature wear or failure. This enhancement enables the SPA 100, 402a-e to operate at significantly higher pressures and facilitates the use of the HCR (for example with a hardness range of 70 to 80 shore A). Optionally, it may also facilitate the use of the HCR beyond said range as well. The webbing feature can be added to any of the designs to improve the life cycle, however, requires a fresh mould to be machined. The design modifications result in mitigation of high-stress regions within the SPA 100, 402a-e, which combined with a 60 percent reduction in finger length, enhances overall performance by enabling a high force output while minimizing risk of material fatigue and failure during operation.

A technical effect of the webbed feature 200 in the lateral valley regions is that it enhances the structural integrity of the SPA 100, 402a-e, ensuring prolonged operational reliability and improved mechanical performance by reducing localized stress accumulation.

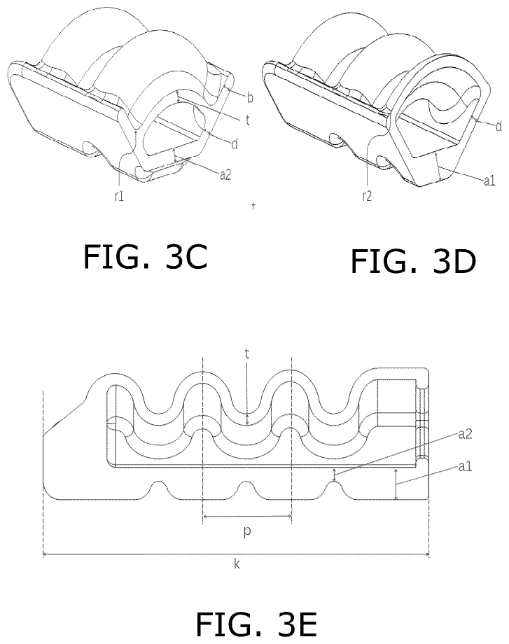

Referring to FIGS. 3A, 3B, 3C, 3D, and 3E, illustrated are different exemplary cross-sectional views of webbing feature incorporated in the SPA 100, 402a-e, in accordance with an embodiment of the present disclosure. Herein, the webbing between bellows can be visualized using the following two cross-sectional views (shown as FIG. 3A, and FIG. 3B). Notably, the cross-sectional views (shown as FIG. 3C, FIG. 3D, and FIG. 3E) can be used to define parameters to constrain the parameters of the webbed feature. These parameters are defined as follows:
a1=maximum thickness of a strain-limiting layer (with a dimensional notation of L¹M⁰T⁰),
a2=minimum thickness of a strain-limiting layer (with a dimensional notation of L¹M⁰T⁰),
d=thickness of a side wall in the bellowed region (with a dimensional notation of L¹M⁰T⁰),
b=thickness of Webbing (with a dimensional notation of L¹M⁰T⁰),
r1=maximum fillet radius of the Webbing (with a dimensional notation of L¹M⁰T⁰),
r2=minimum fillet radius of the Webbing (with a dimensional notation of L¹M⁰T⁰),
n=number of bellows defined as an integer number of p sections along the length k (with a dimensional notation of L⁰M⁰T⁰),
k=length of the soft finger (with a dimensional notation of L¹M⁰T⁰),
p=pitch/separation of bellows (with a dimensional notation of L⁰M⁰T⁰),
x=geometry factor relating b, a1 and a2 (with a dimensional notation of L⁰M⁰T⁰),
y=geometry factor relating t and p (with a dimensional notation of L⁰M⁰T⁰).

In this regard, for an existing base variant of the soft finger 102 to be modified and have the webbed feature, the following parameters must be satisfied:
for a given d:
   b≤d,
for a given a1, a2:
   b≤a2,
   b<a1,
   for an optimal finger function, b=x*a1 (where 0.20<x<0.60)
for a given p:
   r1≤p/2
   r2<r1
for a given t:
   t≤b.

The above independent parameters: d, a1, a2, p, t, and k can be related to the following guidelines:
t≤a1 and a2
t≤y*p, where y>0.25)
k>p.

In one embodiment, optionally, a value of p lies in a range of 5 millimetres (mm) to 30 mm and a value of k lies in a range of 45 mm to 150 mm. In other embodiments, more optionally, a value of p lies in a range of 5 mm to 20 mm and a value of k lies in a range of 60 mm to 110 mm. In an example, a value of p may be equal to 16.10 mm and a value of k may be equal to 59.98 mm. In another example, a value of p may be equal to 12 mm and a value of k may be equal to 106 mm.

Herein, the term “fillet radius” refers to a radius of a rounded curve or an edge that is introduced at a junction or an intersection between two surfaces, typically between a flat and a curved or two adjacent flat surfaces, to remove sharp corners. In manufacturing designs, a fillet is used to reduce stress concentration and enhance structural integrity by distributing stress more evenly across curved surface, as opposed to a sharp corner where stress can accumulate. Herein, the fillet radius is the specific measurement of this curved transition, and it is critical in ensuring both mechanical performance and durability of components, especially in applications where parts are subjected to varying loads or high pressure. In case of the SPA 100, 402a-e, the webbing fillet radius at the valley regions helps to prevent excessive stress buildup during actuation, prolonging life of components and allowing the SPA 100, 402a-e to withstand higher pressures.

FIGS. 3A-E are merely examples, which should not unduly limit the scope of the claims herein. A person skilled in the art will recognize many variations, alternatives, and modifications of embodiments of the present disclosure.

Optionally, a geometry of the soft finger 102 is constructed using one of: a ruled surface modeling, a revolved bellow-based modeling, based on at least one of: a predefined guide curve, a predefined cross-sectional profile. In this regard, the term “ruled surface modeling” refers to a geometric design method in which a surface is generated by sweeping a straight line along a predefined spatial path. This technique enables creation of complex yet smooth surfaces by defining how a line moves through space, ensuring a controlled transition between different sections of the model. Moreover, the term “revolved bellow-based modeling” is a geometric design technique in which a bellowed structure is generated by rotating a predefined cross-sectional profile around a central axis. This approach is commonly used for designing the SPA 100, 402a-e with symmetric, concentric bellows, allowing for controlled expansion and contraction under pneumatic pressure. Moreover, the term “predefined guide curve” refers to a mathematically defined trajectory that dictates overall shape or spatial path of a structure. In context of the SPA 100, 402a-e, the predefined guide curve serves as a reference along which a geometry of the soft finger 102 is constructed, ensuring that a final shape adheres to specific design constraints and functional requirements. Moreover, the term “predefined cross-sectional profile” refers to a predetermined geometric shape that defines structure of a component at a specific cross-section along its length. When applied to the SPA 100, 402a-e, the predefined cross-sectional profile determines varying thickness, contour, or structural characteristics at different points, optimizing flexibility and deformation behavior. Optionally, the predefined guide curve is any one of: a sinusoidal curve, a cosinusoidal curve, a triangular waveform, a square waveform, and the predefined cross-sectional profile is any one of: a rectangular cross-sectional profile, an elliptical cross-sectional profile, a super-elliptical cross-sectional profile, a semi-circular cross-sectional profile, a conical cross-sectional profile, a triangular cross-sectional profile, a wedge-shaped cross-sectional profile, a trapezoidal cross-sectional profile.

Herein, the ruled surface modelling involves generating surfaces by sweeping a straight line along predefined guide curves or cross-sectional profiles. Herein, all differential Fourier transforms can be applied to these waveforms to obtain complex profiles, and similar. Moreover, the revolved bellow-based modeling designs may also include angular cut sections, with angles constrained within a range that may lie from 1 degree<Revolve(θ)<360 degrees, allowing for partial or full revolutions depending on the design requirements. This approach offers high flexibility and customization in design of the SPA 100, 402a-e by combining advanced geometric profiles, waveforms, and transform techniques, allowing the creation of complex actuators tailored to specific motion, force, and pressure characteristics. It will be appreciated that such designs can improve the functional range, adaptability, and precision of the SPA 100, 402a-e in various applications, such as robotics, medical devices, and similar. Moreover, it will be appreciated that using the ruled surface modeling and the revolved bellow-based modeling allows for high precision in shaping the soft finger 102, leading to predictable deformation behavior. Furthermore, it will be appreciated that these modeling techniques enables creation of the soft finger 102 with optimized stress distribution, thereby reducing weak points and enhancing durability. Furthermore, it will be appreciated that the predefined guide curve and the cross-sectional profile allows customization of a design of the soft finger 102, making it adaptable for different gripping or manipulation tasks.

A technical effect of the aforementioned feature is that the SPA 100, 402a-e achieves enhanced mechanical reliability and consistent performance by ensuring that the soft finger 102 deforms in a controlled and predictable manner under pneumatic pressure.

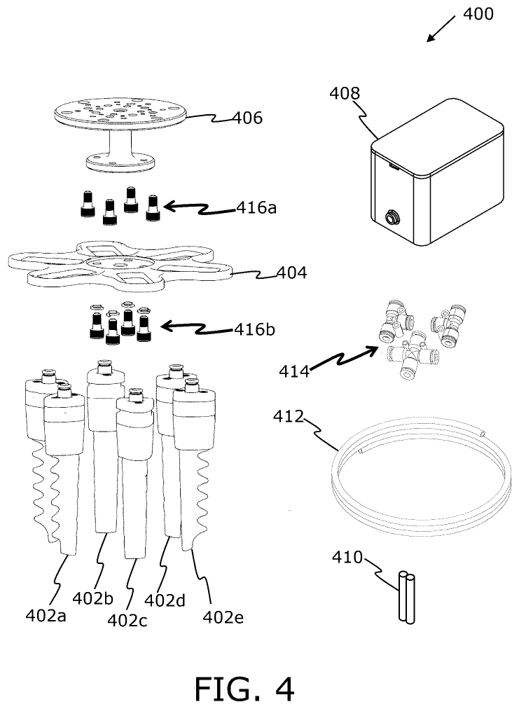

Referring to FIG. 4, illustrated is a structural representation of a gripper assembly 400, in accordance with an embodiment of the present disclosure. The gripper assembly 400 comprises at least one soft pneumatic actuator (for example, depicted as five soft pneumatic actuators 402a, 402b, 402c, 402db, and 402e), a frame 404 configured to support the SPA 100, 402a-e, an arm connector 406 configured to connect the frame 404 to a robotic arm that is to be deployed for performing at least one object manipulation task; a controller box 408 comprising at least one electrically-actuated element to control an actuation of the SPA 100, 402a-e; and at least one pneumatic coupling element configured to pneumatically couple a pneumatic connector 104 of the SPA 100, 402a-e with a pneumatic source 410. Herein, the at least one pneumatic coupling element comprises a pneumatic tube 412, pneumatic fittings 414, and plurality of fasteners 416a, and 416b).

FIG. 4 is merely an example, which should not unduly limit the scope of the claims herein. A person skilled in the art will recognize many variations, alternatives, and modifications of embodiments of the present disclosure.

Throughout the present disclosure, the term “gripper assembly” refers to a mechanical device designed to securely hold, manipulate, and release objects. The design of the gripper assembly 400 is optimized for specific applications, allowing for precise control and adaptability in handling a wide range of shapes and sizes of objects. The term “frame” refers to a structural support element configured to securely hold and align components of the gripper assembly, including the at least one SPA 100, 402a-e. The frame 404 provides mechanical stability, ensuring proper positioning and operation of the SPA 100, 402a-e while withstanding external forces encountered during object manipulation tasks. Herein, the frame 404 is mount to the SPA 100, 402a-e and is capable of providing configurations of the SPA 100, 402a-e. Optionally, the frame 404 is made up of anodized aluminium. This provides a durability to the frame 404, reduces an overall weight of the gripper assembly 400, and maintains a structural integrity of the frame 404. This is particularly important in high-precision applications where minimizing load on robotic arms is crucial for efficiency and longevity. The term “arm connector” refers to a mechanical interface that facilitates attachment of the frame 404 to a robotic arm. The arm connector 406 is designed to transmit forces and motion from the robotic arm to the gripper assembly 400 while maintaining structural integrity. The arm connector 406 may include fasteners, joints, or adaptable mounting features to ensure compatibility with various robotic systems. Optionally, the arm connector 406 is designed to suit different types of robotic arms for versatile deployment. The arm connector 406 is configured to connect the frame 404 to the robotic arm that is to be deployed for performing at least one object manipulation task, for example, such as object grasping, object holding, object releasing, and the like.

The term “controller box” refers to an enclosed housing that contains at least one electrically-actuated element (such as a solenoid valve) for controlling the actuation of the at least one SPA 100, 402a-e. The controller box 408 regulates air pressure, timing, and actuation sequences using components such as solenoid valves, electronic pressure regulators, and microcontrollers, thereby enabling precise manipulation of objects. It will be appreciated that the controller box 408 can be enclosed to protect its internal components (for example, from dust and moisture) and to enhance operational reliability in diverse environments. The term “pneumatic coupling element” refers to an interface designed to establish a pneumatic connection between a pneumatic source 410 and the pneumatic connector 104 of the SPA 100, 402a-e. The pneumatic coupling element ensures a sealed and controlled transfer of pressurized air, enabling consistent and efficient operation of the SPA 100, 402a-e during gripping and releasing tasks. It will be appreciated that the plurality of pneumatic fittings 414 are designed to minimize air leaks and ensure consistent actuation performance. In other words, the pneumatic fittings 414 are designed to facilitate easy assembly and disassembly while minimizing air leaks.

Herein, the gripper assembly 400 is designed to facilitate precise, adaptable, and safe object manipulation in robotic applications. The inclusion of the at least one SPA 100, 402a-e enables compliant gripping, making it suitable for handling delicate, irregularly shaped, or fragile objects without causing damage. The structured integration of the frame 404, the arm connector, the controller box, and the at least one pneumatic coupling element ensures a seamless operation within automated systems. Optionally, the gripper assembly 400 further comprises a plurality of fasteners 416a-b configured to securely connect the frame 404 and the arm connector. This ensures reliable mechanical integrity during an operation of the robotic arm, even under dynamic loads. Optionally, the gripper assembly 400 is configured for modular integration of additional components (for example at least one sensor (such as an image sensor)), to enhance its functionality. Optionally, the gripper assembly 400 is designed as an electrostatic discharge (ESD)-safe variant for handling sensitive electronic components. Optionally, the gripper assembly 400 is configured to operate in underwater environments. Optionally, the gripper assembly 400 is configured to operate in a temperature range of −40 degrees Celsius (° C.) to 220 ° C. Optionally, the at least one SPSA is configured for vacuum-based actuation.

Optionally, the frame 404 comprises at least one rail slot for adjustable positioning of the at least one SPA 100, 402a-e to accommodate different operational requirements. In this regard, the term “rail slot” refers to a linear guiding feature integrated into a structural component, such as the frame 404, to facilitate adjustable positioning of an attached element along a predefined path. Typically, the at least one rail slot comprises a channel, a groove, or a track that allows a sliding or a locking mechanism to reposition components while maintaining stability and alignment. In context of the gripper assembly 400, the at least one rail slot enables precise and adaptable placement of the at least one SPA 100, 402a-e, allowing for modifications in spacing and orientation based on operational requirements. The at least one rail slot may incorporate locking mechanisms, fastening elements, detents and similar, to secure the at least one SPA 100, 402a-e in place after adjustment. Herein, the at least one SPA 100, 402a-e is mounted on an adjustable interface, such as a sliding bracket or a locking mechanism, which allows movement along the at least one rail slot. Once the desired position is determined, fasteners or locking elements secure the at least one SPA 100, 402a-e in place, preventing unintended movement during operation. This configuration allows for quick adjustments without requiring disassembly, making the gripper assembly 400 adaptable to various use cases. For example, handling varying object sizes, shapes, and orientations (such as fragile or irregularly-shaped objects), operating in extreme temperature ranges, functioning in underwater environments, ensuring electrostatic discharge (ESD) safety when handling sensitive electronic components.

A technical effect of incorporating the at least one rail slot into the frame 404 is that the gripper assembly 400 gains enhanced adaptability and versatility, enabling it to accommodate a wide range of object manipulation tasks with minimal reconfiguration. This feature improves efficiency, reduces downtime, and enhances overall usability of the SPA 100, 402a-e in various applications, such as in robotic automation, medical handling, industrial material handling, and similar.

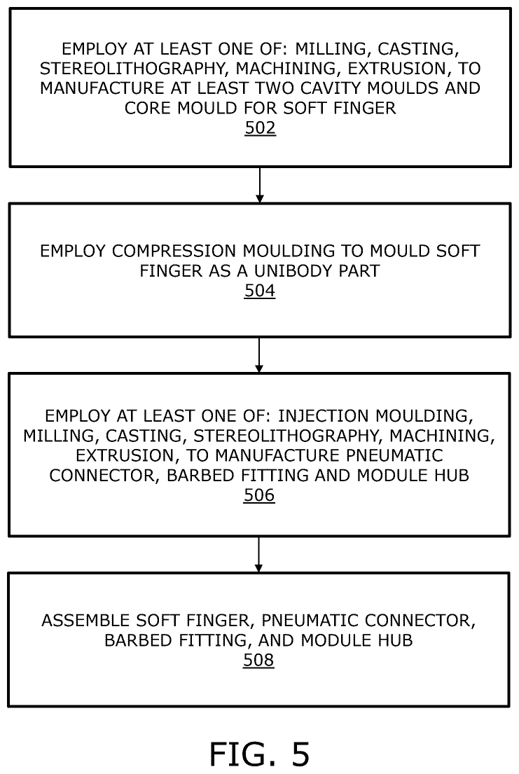

Referring to FIG. 5, illustrated are steps of a method for manufacturing at least one soft pneumatic actuator, in accordance with an embodiment of the present disclosure. At step 502, at least one of: milling, casting, stereolithography, machining, extrusion, is employed to manufacture at least two cavity moulds and a core mould for a soft finger, wherein the at least two cavity moulds define an external geometry of the soft finger, and the core mould defines an internal geometry of the soft finger. At step 504, compression moulding is employed to mould the soft finger as a unibody part using the at least two cavity moulds, the core mould, and a flexible material for the soft finger. At step 506, at least one of: injection moulding, milling, casting, stereolithography, machining, extrusion, is employed to manufacture a pneumatic connector, a barbed fitting, and a module hub. At step 508, the soft finger, the pneumatic connector, the barbed fitting, and the module hub are assembled.

The aforementioned steps are only illustrative and other alternatives can also be provided where one or more steps are added, one or more steps are removed, or one or more steps are provided in a different sequence without departing from the scope of the claims herein. Each of these steps is described later in more detail.

Throughout the present disclosure, the term “milling” refers to a subtractive manufacturing process in which a rotary cutting tool removes material from a workpiece to achieve a desired shape and surface finish. The cutting tool moves along multiple axes, enabling precise machining of complex geometries. The milling is commonly used for producing moulds, cavities, and detailed components with tight tolerances. The term “casting” refers to a manufacturing process in which a liquid material (such as a molten metal, a polymer, a silicone, and similar) is poured into a predefined mould cavity and allowed to solidify into a specific shape. Once solidified, the mould is removed to reveal a final component. The casting is widely used for producing the SPA 100, 402a-e moulds due to its ability to replicate intricate details and accommodate flexible materials. The term “stereolithography” refers to an additive manufacturing (i.e., a three-dimensional printing) process that uses a laser or ultraviolet light source to selectively cure and solidify layers of a liquid photopolymer resin into a predefined shape. The stereolithography is known for its high-resolution printing capability, making it suitable for fabricating precise moulds and prototypes of the at least one SPA 100, 402a-e with intricate internal geometries. The term “machining” refers to a material removal process that involves cutting, grinding, drilling, or shaping a workpiece using mechanical tools or computer-controlled machines (CNC machining). The machining ensures tight dimensional tolerances and is commonly used for producing metal or polymer moulds for the at least one SPA 100, 402a-e. The term “extrusion” refers to a manufacturing process in which a material (such as a rubber, a plastic, a metal, and similar) is forced through a shaped die to create continuous profiles with a uniform cross-section. The extrusion is often used for producing tubular or bellowed structures in the at least one SPA 100, 402a-e, enabling seamless, high-strength designs suitable for pneumatic applications. The aforesaid manufacturing processes are well-known in the art.

The term “core mould” refers to a mould component that defines an internal geometry of a moulded part by creating hollow sections, channels, or cavities within a final structure. In the SPA 100, 402a-e, the core mould 606 is used to form an internal air channels or chambers that facilitate pneumatic actuation. The core mould 606 is typically placed within the cavity moulds before material is introduced to shape the internal features of the soft finger 102. The term “cavity mould” refers to a mould component that defines an external geometry of a moulded part. The cavity moulds form an outer surface shape and structural features by enclosing a material within a predefined cavity. In the SPA 100, 402a-e, the at least two cavity moulds 602, 604 are used to shape the external profile of the soft finger 102, ensuring proper mechanical integrity, flexibility, and deformation characteristics.

Herein, the method involves employing the at least one of: milling, casting, stereolithography, machining, extrusion to manufacture the at least two cavity moulds 602, 604 and the core mould 606 for forming the soft finger 102. This step is integral to the fabrication of the at least one SPA 100, 402a-e and ensures that the soft finger 102 is precisely shaped with the required external and internal geometries. Optionally, prior to performing this step, the method further comprises designing the at least one mould and the core mould 606 using at least one designing software. It will be appreciated that using precise fabrication techniques ensures that the soft finger 102 has well-defined external and internal geometries, leading to consistent actuation behavior. It will also be appreciated that a well-defined core mould results in precisely shaped internal air channels, enabling uniform pressure distribution and predictable deformation. Optionally, the core mould 606 comprises an enlarged cylindrical portion configured to facilitate a removal of the core mould 606 from a moulded soft finger. It will be appreciated that an enlarged cylindrical portion of the core mould 606 directly results in a formation of a corresponding enlarged cylindrical portion in the moulded soft finger 102 (at the second end). This enlarged cylindrical portion in the soft finger 102 is designed to interface with the barbed fitting 106 at the second end 112b. Thus, the barbed fitting 106 is intentionally oversized to match the enlarged cylindrical portion of the soft finger 102, ensuring a strong pneumatic seal therebetween.

Throughout the present disclosure, the term “compression moulding” refers to a manufacturing process in which a preheated or uncured material (such as elastomers, thermosetting polymers, composites, and similar) is placed into a mould cavity and then subjected to heat and pressure to form a desired shape. The process ensures uniform material distribution and precise replication of intricate features. The compression moulding is commonly used in applications requiring high structural integrity, durability, and complex geometries, such as soft robotic actuators, medical devices, automotive components, and similar.

Herein, the at least two cavity moulds 602, 604 are positioned to define an external structure of the soft finger 102, while the core mould 606 is placed inside to create an internal air channels or chambers required for pneumatic actuation. A flexible material (e.g., silicone, rubber, and the like) may be preheated and placed into the mould assembly. During the compression moulding process, the at least two cavity moulds 602, 604 are pressed together under controlled pressure and temperature, causing the flexible material to flow and conform to both the internal and external geometries of the mould assembly. The material is then cured (i.e., hardened) through heat or chemical cross-linking, ensuring formation of a precisely shaped soft finger 102. Once the curing process is completed, the soft finger 102 is removed from the mould as a unibody part with precisely formed actuation features. A technical effect of employing the compression moulding is that the soft finger 102 is manufactured with high structural integrity, uniform flexibility, and optimized pneumatic actuation properties. The unibody part construction reduces mechanical failure points, enhances durability, and ensures predictable deformation behavior for applications such as robotic grippers, soft actuators, and similar.

Optionally, when employing the compression moulding, the method further comprises at least one of:
selecting a flexible material for the soft finger 102, based on an operational requirement of the at least one SPA 100, 402a-e;
positioning a parting line on the at least two cavity moulds 602, 604;
inserting the core mould 606 into a mould cavity formed by the at least two cavity moulds 602, 604;
placing a predefined amount of the flexible material into the mould cavity;
applying at a predetermined temperature and a predetermined pressure for a predetermined time to ensure uniform material flow and bonding to cure the flexible material, thereby forming the soft finger 102;
removing the core mould to extract the formed soft finger 102;
employing machining for trimming excess flexible material along the parting line;
conducting quality checks to verify structural integrity and/or dimensional accuracy of the soft finger 102.

Moreover, a parting line along a length of the soft finger 102 can be defined by using following parameters, i.e., the parting line is present at a locus of points on either side of transverse section of the soft finger 102 where a tangent to the curve is perpendicular to the base (i.e., horizontal plane) of the soft finger 102. This design prevents any concave geometry at an interface of the moulds. Also, it does not form a parting line at any interface between the strain limiting layer and the hollow bellowed structure 110, only present in one stratum in a particular finger. Notably, the term “parting line” refers to a visible seam or a boundary on a moulded part where two or more sections of a mould come together during manufacturing process. The parting line occurs at an interface of the mould components and represents a point at which the mould halves (or other sections) meet. The location and geometry of the parting line is essential to maintain uniformity and preventing defects, as it directly influences surface finish of the part, structural integrity, and ease of demoulding. Moreover, a proper placement of the parting line is essential to minimize flash formation and ensure high-quality final products. It will be appreciated that this design, where the parting line is positioned along the locus of points on either side of transverse section of the soft finger 102 with the tangent perpendicular to base, effectively prevents concave geometries at the mould interface. This not only ensures a uniform and smooth surface but also enhances the structural integrity of the SPA 100, 402a-e, thereby minimizing weak points and material inconsistencies. Additionally, by avoiding the formation of the parting line at the interface between the strain-limiting layer and the hollow bellowed structure 110, the SPA 100, 402a-e maintains optimal flexibility and performance in these critical areas.

Throughout the present disclosure, the term “injection moulding” refers to a manufacturing process in which a molten material, such as a thermoplastic, a thermosetting polymer, a rubber, a metal, and similar, is injected under high pressure into a precisely designed mould cavity. Herein, the pneumatic connector 104, the barbed fitting 106, and the module hub 108 can be manufactured using different fabrication techniques, such as the injection moulding, the milling, the casting, the stereolithography, the machining, the extrusion, based on a desired material, precision, and production scale. These fabrication techniques are well-known in the art. Optionally, prior to performing this step, the method further comprises designing these components of the at least one SPA 100, 402a-e using the at least one designing software.

It will be appreciated that by employing the injection moulding, the manufacturing of the pneumatic connector 104, the barbed fitting 106, and the module hub 108 is facilitated with high precision, repeatability, and mass production efficiency, ensuring uniform dimensional accuracy and optimized material usage while reducing production costs. Optionally, it will be appreciated that by employing the milling, the pneumatic connector 104, the barbed fitting 106, and the module hub 108 can be fabricated with high dimensional accuracy and tight tolerances, allowing for the production of customized components with superior mechanical strength and durability, particularly when using metals and plastics. Optionally, it will be appreciated that by employing the casting, complex pneumatic connectors and barbed fittings can be produced with minimal post-processing, enabling cost-effective manufacturing of medium to large batches with high material strength, particularly in metal or polymer-based applications. Optionally, it will be appreciated that by employing the stereolithography (SLA), the pneumatic connector 104, the barbed fitting 106, and the module hub 108 can be fabricated with intricate internal structures and rapid prototyping capabilities, allowing for quick design iterations, minimal material waste, and ability to produce highly complex geometries that would be challenging with traditional methods. Optionally, it will be appreciated that by employing the machining, the pneumatic connector 104, the barbed fitting 106, and the module hub 108 can be manufactured with precise features, high durability, and optimal sealing performance, particularly for high-pressure pneumatic applications, while enabling modifications such as threading, grooving, or fine detailing. Optionally, it will be appreciated that by employing the extrusion, the pneumatic connector 104, the barbed fitting 106, and the module hub 108 can be produced efficiently in long, uniform sections with consist material properties, making it particularly suitable for tubular or linear-profile components in large-scale production while ensuring minimal material waste and high manufacturing throughput.

After performing the aforementioned steps of the method, the soft finger 102, the pneumatic connector 104, the barbed fitting 106, and the module hub 108 are assembled. Herein, the assembly of the soft finger 102, the pneumatic connector 104, the barbed fitting 106, and the module hub 108 involves securely integrating these components to form the SPA 100, 402a-e. The pneumatic connector 104 is affixed to the soft finger's 102 inlet port, creating a sealed interface for controlled air transmission. The barbed fitting 106 is then inserted into or attached to the pneumatic connector 104, ensuring a secure and airtight connection with the pneumatic tubing. The module hub 108 is positioned to support the soft finger 102 structurally, providing necessary mounting features for integration into a larger robotic system. The assembly process may employ fastening techniques such as interference fits, adhesives, mechanical locking, and similar, to ensure structural integrity, prevent air leakage, and maintain consistent pneumatic actuation performance.

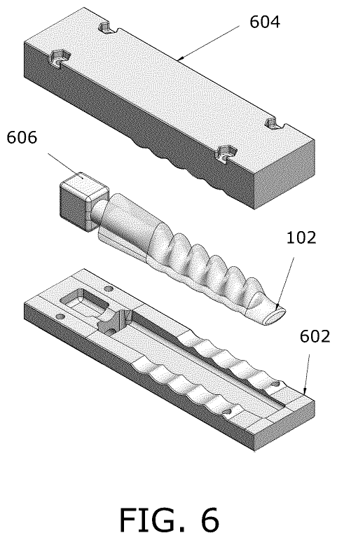

Referring to FIG. 6, illustrated is a representation of a three-part mould for production of the soft finger 102, in accordance with an embodiment of the present disclosure. Herein, at least two cavity moulds (depicted as two cavity moulds 602, and 604) and a core mould 606 for the production of the soft finger 102 are shown. The soft finger 102 is formed by placing the core mould 606 inside the two cavity moulds 602 and 604, which defines an external and internal geometries of the soft finger 102 during the moulding process.

FIG. 6 is merely an example, which should not unduly limit the scope of the claims herein. A person skilled in the art will recognize many variations, alternatives, and modifications of embodiments of the present disclosure.

Optionally, the at least two cavity moulds 602, 604 and the core mould 606 are interchangeable to enable production of at least one variant of the soft finger 102. In this regard, a mould system is designed with standardized interfaces or alignment features to facilitate easy swapping of cavity and core moulds. Different cavity moulds may be used to alter the external geometry of the soft finger 102, such as its shape, thickness, surface texture, and similar. Different core moulds may be used to modify the internal pneumatic channels, changing actuation behavior. The moulding process (e.g., compression moulding, and similar) may be applied after assembling selected combination of the at least two cavity moulds 602, 604 and the core mould 606. Once the material is cured, the at least one soft finger 102 variant is removed, and moulds can be reconfigured for a next variant. This flexibility enables for rapid changes in design or functionality, optimizing production efficiency and adaptability for various applications. It will be appreciated that this feature significantly reduces need for extensive retooling, thereby lowering operational costs and lead times while enhancing ability of a manufacturer to respond to market demands and customer requirements effectively. Herein, when different variants of the soft finger 102 are possible, each variant of the soft finger 102 would have particular geometrical characteristics. A technical effect of employing interchangeable cavity moulds and the core mould 606 is that the method enables scalable and cost-effective production of the at least one soft finger 102 variant without requiring a full set of unique moulds for each design. This modular approach improves manufacturing efficiency, reduces tooling costs, and enhances adaptability in applications such as in robotic grippers, medical devices, and other soft actuator-based systems.

Optionally, the parting line is positioned on the at least two cavity moulds 602, 604 to ensure material uniformity in critical pressurized regions of the soft finger 102, minimize flash formation during the compression moulding, and simplify post-processing of the soft finger 102. Optionally, the post-processing of the soft finger 102 comprises trimming excess flexible material along the parting line and conducting surface finishing to ensure a smooth and defect-free surface of the soft finger 102. Optionally, the core mould 606 is designed with an oversized cylindrical portion to facilitate easy removal of the soft finger 102, upon its formation, without damaging the internal geometry of the soft finger 102. Optionally, the method further comprises selecting one of: tall bellows, short bellows, based on an aspect ratio of a smallest cross-section of a given SPA 100, 402a-e to a seal opening of the given SPA 100, 402a-e. Optionally, the method further comprises: testing the at least one SPA 100, 402a-e for operational reliability under various conditions comprising high pressure, temperature extremes, underwater environments; and certifying the at least one SPA 100, 402a-e for a real-world application (for example, such as food safety or medical use).

Optionally, a design of the at least two cavity moulds 602, 604 takes into account a flash groove arranged along a geometrical contour of the soft finger 102, to control excess flexible material during the compression moulding and to ensure material uniformity in critical pressurized regions of the soft finger 102. In this regard, the term “flash groove” refers to a recessed feature designed into a mould to accommodate any excess material or flash that escapes from cavity during the moulding process. Typically, flash occurs when a small amount of material flows into a space between mould parts or along the parting line. Herein, the flash groove helps to control this excess material by directing it into predefined channels, thus preventing the flash from affecting dimensions, surface finish, functional integrity, and similar, of the SPA 100, 402a-e. Herein, the strategic placement of the flash grooves optimizes material integrity, while the enlarged core design streamlines production by facilitating easier core removal. Moreover, the term “geometrical contour” refers to a defined shape, a profile, or an outline of a three-dimensional object, as represented by its spatial boundaries. In the context of moulding and manufacturing, the geometrical contour defines an external features and/or an internal features of a component, ensuring that it conforms to a precise design specification for functionality and structural performance.

In an implementation, the at least two cavity moulds 602, 604 are designed with the flash groove strategically positioned along the geometrical contour of the soft finger 102. During compression moulding, the flexible material (e.g., silicone, rubber, and similar) may be compressed between the moulds, and excess material is pushed into the flash groove. In this regard, the controlled accumulation of excess material within the flash groove prevents unwanted variations in material thickness across the soft finger 102. The flash groove is dimensioned to ensure that any excess material can be efficiently removed after curing, leaving a smooth, uniform surface on a final product. Such an approach ensures that the parting line does not create heterogeneous material regions near a pressurized volume of the soft finger 102.

A technical effect of employing the flash groove in the design of the at least two cavity moulds 602, 604 is the enhancement of structural integrity and performance consistency of the soft finger 102. The method ensures that pressurized regions (such as internal pneumatic channels or bending zones) maintain a consistent material distribution for optimal pneumatic actuation, thereby preventing defects that could lead to air leaks, uneven actuation, premature failure, and similar.

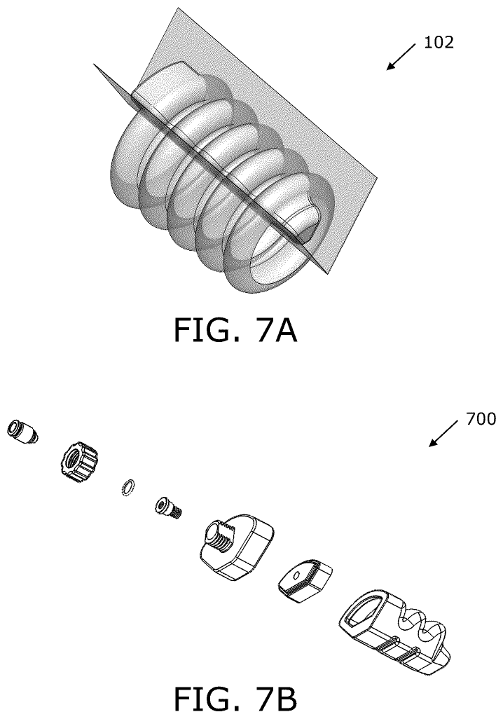

Referring to FIG. 7A, illustrated is a construction technique for modelling of the soft finger 102 of an exploded views of the SPA 700 (as shown in FIG. 7B, and 7C), in accordance with an embodiment of the present disclosure.

Herein, to achieve the desired design specifications, a Finite Element Analysis (FEA) approach may be utilized. This technique facilitates an evaluation of various geometric combinations to identify optimal configuration for the soft finger 102 (as shown in FIGS. 1, 7B, and 7C). By controlling key parameters for example, such as a length, a width, number of bellows, taper angle(s), and similar, the modelling method allows for the customization of the soft finger 102, a web feature to meet specific application requirements by simply modifying a select few parameters.

FIGS. 7A-C are merely examples, which should not unduly limit the scope of the claims herein. A person skilled in the art will recognize many variations, alternatives, and modifications of embodiments of the present disclosure.

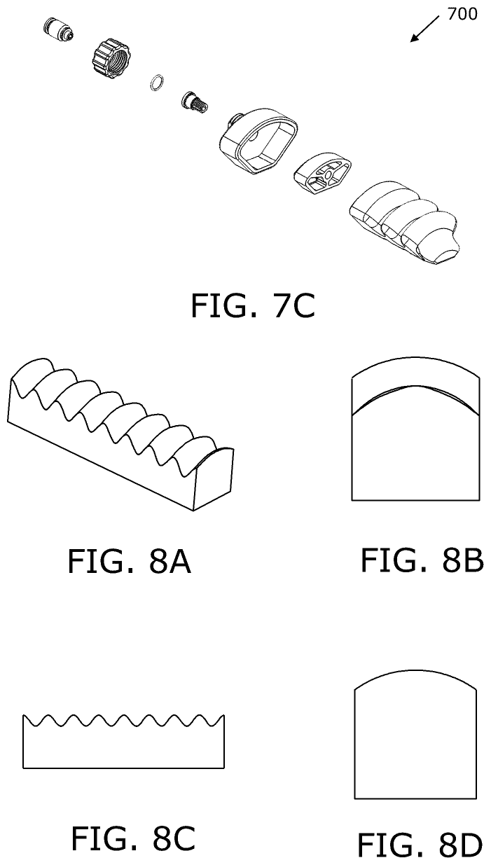

Referring to FIGS. 8A, 8B, 8C, and 8D, illustrated are different exemplary views of revolve bellow-based modelling of a soft finger with super eclipse cross sections and cosinusoidal guide curves, in accordance with an embodiment of the present disclosure.

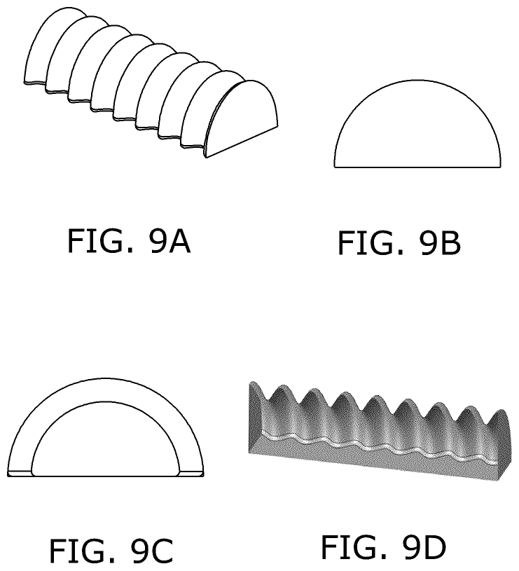

Referring to FIGS. 9A, 9B, 9C, and 9D, illustrated are different exemplary views of revolve bellow-based modelling of a soft finger with conic semicircular sections and cosinusoidal guide curves, in accordance with another embodiment of the present disclosure.

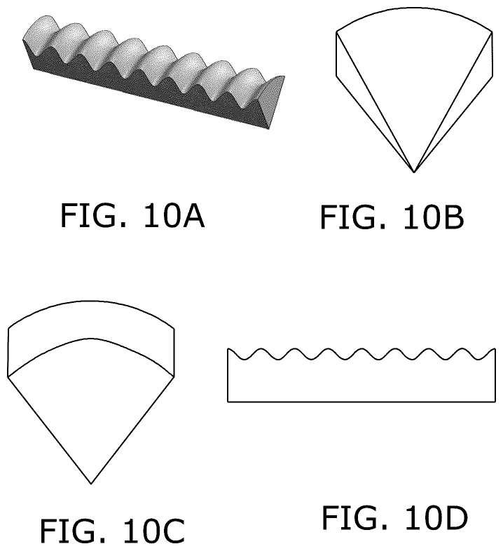

Referring to FIGS. 10A, 10B, 10C, and 10D, illustrated are different exemplary views of revolve bellow-based modelling of a soft finger with triangular sections and cosinusoidal guide curves, in accordance with yet another embodiment of the present disclosure.

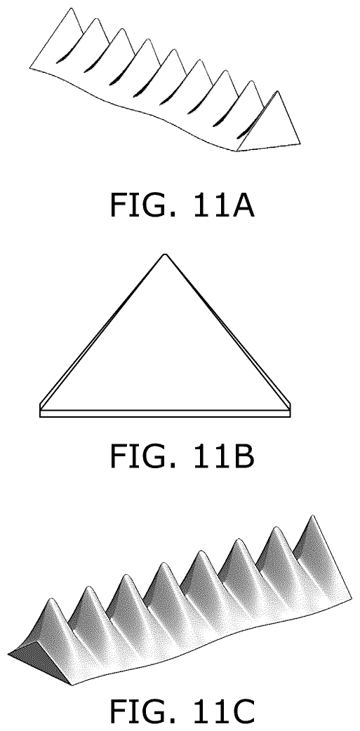

Referring to FIGS. 11A, 11B, and 11C, illustrated are different exemplary views of rule surface modelling of a soft finger with triangular sections and cosinusoidal guide curves, in accordance with still another embodiment of the present disclosure.

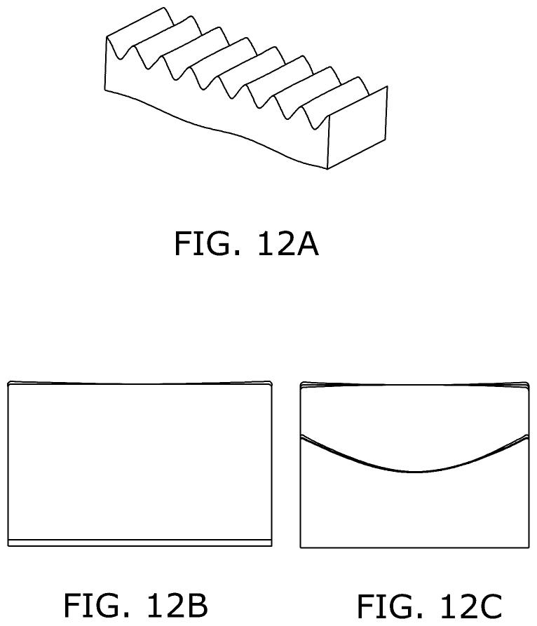

Referring to FIGS. 12A, 12B, and 12C, illustrated are different exemplary views of rule surface modelling of a soft finger with super ellipse cross sections and cosinusoidal guide curves, in accordance with yet another embodiment of the present disclosure.

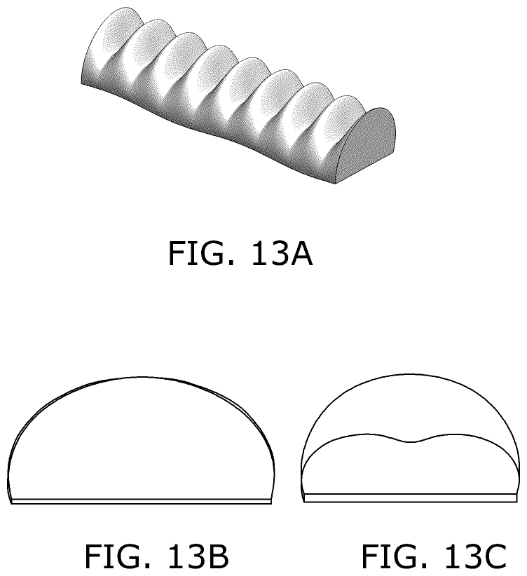

Referring to FIGS. 13A, 13B, and 13C, illustrated are different exemplary views of rule surface modelling of a soft finger with conic semicircular sections and cosinusoidal guide curves, in accordance with still another embodiment of the present disclosure.

FIGS. 8A-D, 9A-D, 10A-D, 11A-C, 12A-C, and 13A-C are merely examples, which should not unduly limit the scope of the claims herein. A person skilled in the art will recognize many variations, alternatives, and modifications of embodiments of the present disclosure.

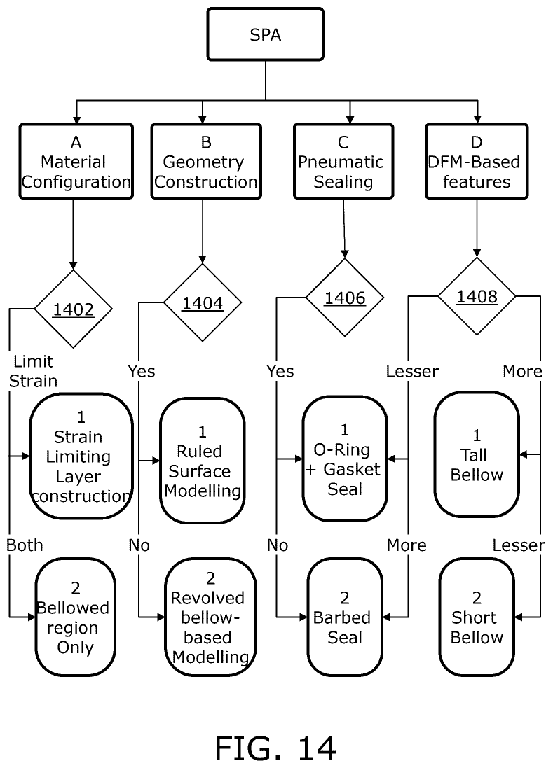

Referring to FIG. 14, illustrated is an exemplary process flowchart representing a manufacturing process (i.e., a development process) of a soft pneumatic actuator, in accordance with an embodiment of the present disclosure. Herein, the development process is divided into four main areas of consideration, i.e., Material Configuration (A), Geometry Construction (B), Pneumatic Sealing (C), and Design for Manufacturability (DFM)-based features (D). In Material Configuration (A), at step 1402, it is checked whether a material is used to limit and allow strain, both. If it is used solely to limit strain, a Strain Limiting Layer Construction is selected. If the material serves both functions, it leads to Bellowed Region ONLY construction. It will be appreciated that clear distinction between strain-limiting layers and bellowed regions ensures materials are effectively chosen based on whether they need to restrict or allow deformation, which enhances durability and flexibility where needed. In Geometry Construction (B), at step 1404, it is checked whether the strain-limiting layer and bellow regions are a single surface. If they are, Ruled Surface Modelling is applied, where surfaces are created based on guide curves. If not, the design follows Revolved Bellow-based Modelling, where cross-sections are revolved to form the hollow bellowed structure. It will be appreciated that by providing a decision path between the Ruled Surface Modelling and the Revolved Bellow-based Modelling, designers can adjust geometry for specific applications, allowing for smoother and more predictable deformation patterns in a structure of the SPA. In Pneumatic Sealing (C), at step 1406, it is checked whether the pneumatic sealing require additional rubber or silicone components. If the answer is yes, an O-Ring plus Gasket Seal is employed. If no additional components are necessary, a Barbed Seal is chosen for pneumatic integrity. The inclusion of a decision-making process for the Pneumatic Sealing (for example, such as O-ring, gasket, barbed seal, and the like) ensures that airtightness of the SPA is maintained without over-complicating the design, leading to improved sealing performance while reducing material costs and assembly complexity. In DFM-based features (D), at step 1408, it is checked whether an aspect ratio of smallest cross-section to the seal opening is 2:1. If the aspect ratio is greater than 2:1, a Tall Bellow configuration may be selected. If less, a Short Bellow may be used to enhance manufacturability. The consideration of the aspect ratios in the DFM-based features ensures that the design of the SPA is optimized for manufacturing processes, leading to reduced production costs, faster assembly, and minimized defects, especially when selecting between Tall and Short Bellows based on structural demands. Furthermore, this optimization supports a refined barbed connection and module design, facilitating ease of assembly and reducing overall number of parts.

FIG. 14 is merely an example, which should not unduly limit the scope of the claims herein. A person skilled in the art will recognize many variations, alternatives, and modifications of embodiments of the present disclosure.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

What is claimed is:

1. A soft pneumatic actuator comprising:
a soft finger moulded as a unibody part, the soft finger comprising:
a hollow bellowed structure capable of being deformed under a pneumatic pressure, the hollow bellowed structure being located between a first end and a second end of the soft finger, a thickness of the second end being greater than a thickness of the first end; and
a strain-limiting layer integrated with the hollow bellowed structure at the first end of the soft finger, wherein the strain-limiting layer is configured to enable a deformation of the hollow bellowed structure in a controlled manner;
a pneumatic connector configured to pneumatically couple the soft finger with a pneumatic source;
a barbed fitting capable of being partially arranged into the second end of the soft finger and partially arranged into the pneumatic connector, to provide a pneumatic sealing between the soft finger and the pneumatic connector; and
a module hub adapted to:
securely hold the soft finger, the pneumatic connector, and the barbed fitting together, during an operation of the soft pneumatic actuator; and
integrate the soft pneumatic actuator into a pneumatic gripper assembly.

2. The soft pneumatic actuator as claimed in claim 1, wherein the soft finger is made up of a flexible material, wherein the flexible material is any one of: a high-consistency rubber, a thermoplastic elastomer.

3. The soft pneumatic actuator as claimed in claim 1, wherein the soft finger further comprises a webbed feature located in lateral valley regions of the soft finger to reduce a stress concentration thereat, during the operation of the soft pneumatic actuator.

4. The soft pneumatic actuator as claimed in claim 1, wherein a geometry of the soft finger is constructed using one of: a ruled surface modeling, a revolved bellow-based modeling, based on at least one of: a predefined guide curve, a predefined cross-sectional profile.

5. The soft pneumatic actuator as claimed in claim 4, wherein the predefined guide curve is any one of: a sinusoidal curve, a cosinusoidal curve, a triangular waveform, a square waveform, and the predefined cross-sectional profile is any one of: a rectangular cross-sectional profile, an elliptical cross-sectional profile, a super-elliptical cross-sectional profile, a semi-circular cross-sectional profile, a conical cross-sectional profile, a triangular cross-sectional profile, a wedge-shaped cross-sectional profile, a trapezoidal cross-sectional profile.

6. The soft pneumatic actuator as claimed in claim 1, wherein the pneumatic connector includes threaded fittings, barbed fittings, quick-connect couplings, or other sealing mechanisms.

7. The soft pneumatic actuator as claimed in claim 1, wherein the barbed fitting is oversized and has an enlarged cylindrical portion, and wherein an oversized portion of the barbed fitting creates a compression seal when inserted into the soft finger and the pneumatic connector.

8. The soft pneumatic actuator as claimed in claim 1, wherein a thickness of an externally-threaded portion of the barbed fitting is in accordance with a thickness of an internally-threaded portion of the second end of the soft finger.

9. The soft pneumatic actuator as claimed in claim 1, wherein the module hub comprises a plurality of parts configured to securely hold the soft finger, the pneumatic connector, and the barbed fitting together, using frictional forces and multiaxial reactive forces.

10. A gripper assembly comprising:
at least one soft pneumatic actuator as claimed in claim 1;
a frame configured to support the at least one soft pneumatic actuator;
an arm connector configured to connect the frame to a robotic arm that is to be deployed for performing at least one object manipulation task;
a controller box comprising at least one electrically-actuated element to control an actuation of the at least one soft pneumatic actuator; and
at least one pneumatic coupling element configured to pneumatically couple a pneumatic connector of the at least one soft pneumatic actuator with a pneumatic source.

11. The gripper assembly as claimed in claim 10, wherein the frame comprises at least one rail slot for adjustable positioning of the at least one soft pneumatic actuator to accommodate different operational requirements.

12. The gripper assembly as claimed in claim 10, wherein the frame is made up of anodized aluminium.

13. The gripper assembly as claimed in claim 10, further comprising a plurality of fasteners configured to securely connect the frame and the arm connector.

14. A method for manufacturing at least one soft pneumatic actuator as claimed in claim 1, the method comprising:
employing at least one of: milling, casting, stereolithography, machining, extrusion, to manufacture at least two cavity moulds and a core mould for a soft finger, wherein the at least two cavity moulds define an external geometry of the soft finger, and the core mould defines an internal geometry of the soft finger;
employing compression moulding to mould the soft finger as a unibody part using the at least two cavity moulds, the core mould, and a flexible material for the soft finger;
employing at least one of: injection moulding, milling, casting, stereolithography, machining, extrusion, to manufacture a pneumatic connector, a barbed fitting, and a module hub; and
assembling the soft finger, the pneumatic connector, the barbed fitting, and the module hub.

15. The method as claimed in claim 14, wherein the at least two cavity moulds and the core mould are interchangeable to enable production of at least one variant of the soft finger.

16. The method as claimed in claim 14, wherein a design of the at least two cavity moulds takes into account a flash groove arranged along a geometrical contour of the soft finger, to control excess flexible material during the compression moulding and to ensure material uniformity in critical pressurized regions of the soft finger.

17. The method as claimed in claim 14, wherein when employing the compression moulding, the method further comprises at least one of:
selecting a flexible material for the soft finger, based on an operational requirement of the at least one SPA;
positioning a parting line on the at least two cavity moulds;
inserting the core mould into a mould cavity formed by the at least two cavity moulds;
placing a predefined amount of the flexible material into the mould cavity;
removing the core mould to extract the formed soft finger;
employing machining for trimming excess flexible material along the parting line;
conducting quality checks to verify structural integrity and/or dimensional accuracy of the soft finger.

18. The method as claimed in claim 14, further comprising designing the at least one mould and the core mould using at least one designing software.
